(19) United States
(12) Patent Application Publication
(10) Pub. No.: US 2004/0074987 A1
(43) Pub. Date: Apr. 22, 2004

(54) Apparatus and method for automatic powder spray booth cleaning

(76) Inventor: Jeffrey R. Shutic, Wakeman, OH (US)

Correspondence Address: Calfee Halter & Griswold, Suite 1400, 800 Superior Avenue, Cleveland, OH, 44114, US

(21) Appl. No.: 10/470,455

(22) PCT Filed: Jan. 30, 2002
(86) PCT No.: PCT/US02/02683

(30) Foreign Application Priority Data
Jan. 31, 2001 (US) 60265836

(51) Int. Cl. B05B 3/00

(52) U.S. Cl. 239/225.1

(57) ABSTRACT

An automatic and pneumatically driven cleaning apparatus and method for cleaning interior surfaces of a powder spray booth. The cleaning apparatus includes a frame that can be transported into the booth by an overhead conveyor. The frame has a number of air jets that blow off powder from the interior surfaces. Propulsion air jets are also provided with the frame to pneumatically cause the frame to rotate. A lower stabilizer hub may be used to stabilize the rotation of the frame. The frame is made of lightweight materials such as composite materials.

### RELATED APPLICATIONS

This application claims the benefit of U.S. Provisional patent application serial No. 60/265,836 filed on Jan. 31, 2001 for AUTOMATIC PNEUMATIC BOOTH CLEANING SYSTEM, the entire disclosure of which IS fully incorporated herein by reference.

### TECHNICAL FIELD OF THE INVENTION

The present invention relates generally to cleaning powder overspray from the interior surfaces of a powder spray booth. More particularly, the invention relates to a powder spray booth cleaning arrangement that uses a pneumatically self-propelled rotatable frame inside the spray booth to blow off powder on the spray booth interior surfaces.

### BACKGROUND OF THE INVENTION

Powder spraying systems are well known. A typical powder spraying system includes a powder source, such as powder stored in a fluidizing hopper. The powder in the hopper may be fluidized using pressurized air, although not all powder spray systems use fluidized powder supplies. The spraying system also includes a powder spray device such as a spray gun that extends into a spray booth. The spray gun is used to spray powder at an object inside the spray booth. The spray booth is used for powder containment and recovery. Many types of spray guns have been developed over the years including electrostatic guns such as corona spray guns and tribo-charging guns. Most powder spraying systems also include a powder collection system to collect powder overspray. Some powder spraying systems use non-electrostatic spray guns.

Powder overspray tends to collect on various interior surfaces of a spray booth. This especially occurs in spraying systems that use electrostatic spray guns. The powder overspray must be removed in order to change the color of the powder being sprayed. Heretofore, spray booth cleaning has tended to be a manually intensive and time consuming effort. Typically, an operator must physically enter the spray booth and use a hand wand or other device to blow off powder from the interior surfaces of the booth. By reducing the amount of time it takes to clean a spray booth of powder overspray, color change cycles can be shortened, which in turn shortens the “off line” time of the spraying system.

Recently a new spray booth concept has been developed. The spray booth is generally round and includes a rotatable booth floor The details of this booth are fully described in U.S. patent application Ser. No. 09/888,679 filed on Jun. 25, 2001 for QUICK CHANGE POWDER COATING SPRAY SYSTEM, the entire disclosure of which is fully incorporated herein by reference. This booth includes a powder extraction system in the form of a negative pressure air duct near the rotating floor to sweep up powder overspray from the floor during a spraying operation. As part of a color change operation, however, even though there is very little residual powder in the spray booth, in some cases an operator will enter the booth in order to blow off powder from the booth interior surfaces.

The present invention is directed to spray booth cleaning arrangements that can minimize the time required to clean a spray booth for a color change operation by eliminating the need for an operator to physically enter the spray booth. The present invention is further directed to providing an automatic and pneumatically operated spray booth cleaning system.

### SUMMARY OF THE INVENTION

In accordance with one aspect of the invention, an automatic pneumatically operated spray booth cleaning arrangement is provided that contemplates a number of blow off air jets that can be transported into the spray booth interior. These air jets blow off powder from interior surfaces of the spray booth including the booth vertically extending walls and the ceiling. In one embodiment the air jets are realized in the form of air nozzles.

In accordance with another aspect of the invention, blow off air jets are transported into a spray booth interior such that the air jets can be rotated about an axis to blow off the interior surfaces. In one embodiment, the blow off air jets are part of a frame or air manifold that has an air passage therethrough. The air jets are in fluid communication with the frame air passage. The frame is mounted for rotation within the spray booth and has vertically extending legs positioned an appropriate distance from interior surfaces of the spray booth vertical wall structure so as to effectively blow off powder. The cleaning frame thus generally conforms to the interior wall structure of the spray booth, particularly while the frame is rotating. In this embodiment, the frame may be suspended from and transported by an overhead conveyor into the spray booth, such as by using for example the same conveyor that is used to transport parts to be sprayed into the spray booth interior. Pressurized air may be coupled to the frame via a suitable rotary coupling associated with the conveyor. The frame may enter the spray booth through access openings in the booth wall structure.

In accordance with another aspect of the invention, rotation of the frame and associated blow off air jets is effected automatically in response to pressurized air introduced into the frame. In one embodiment, a number of propulsion air jets are provided with the frame. The propulsion air jets are oriented at an appropriate angle so as to impart a rotating motion to the frame.

The present invention further contemplates the methods incorporated into use of such apparatus, as well as a method for cleaning a powder spray booth including the steps of transferring into the spray booth a number of blow off air jets and rotating the air jets so as to blow off powder from the interior surfaces of the spray booth. In an additional embodiment of the method, the blow off air jets are associated with a frame that is rotatable within the spray booth by using pressurized air to automatically propel the rotation of the frame. In one embodiment, pressurized air is ejected through a number of propulsion air jets.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and a method of which will be described in detail in this specification and illustrated in the accompanying drawings which form a part hereof, and wherein:

FIG. 1 is a simplified schematic in vertical cross-section of a spray booth with an automatic spray booth cleaning apparatus in accordance with the invention;

FIG. 1A is an enlarged cross-sectional view taken along the line 1A-1A of FIG. 1;

FIG. 2 is a cross-sectional illustration of the invention showing the frame of FIG. 1 in profile;

FIG. 3 illustrates another embodiment of the invention;

FIG. 4 illustrates a lower stabilizer hub; and

FIG. 5 illustrates a coupling mechanism between the frame and and overhead conveyor.

### DETAILED DESCRIPTION OF THE INVENTION

The present invention is directed to apparatus and methods for cleaning the interior surfaces of a powder spray booth with little or no need for an operator to enter the booth interior. A cleaning apparatus is provided that can automatically be transported into the spray booth interior and blow off powder from the interior surfaces. While the invention is described herein with reference to a specific round spray booth configuration, those skilled in the art will readily appreciate that the invention may be used with many different spray booth designs, including round spray booths and spray booths that are not necessarily round. The present invention is also not limited to use with any specific spraying technology and will work as effectively with electrostatic and non-electrostatic spraying technologies. Moreover, although the present invention is described herein along with a number of available alternative embodiments and modifications, such description should not be construed as being an exhaustive list of such alternatives and modifications. Those skilled in the art will readily appreciate that additional modifications or alternative embodiments will be available within the scope and spirit of the present inventions set forth in the appended claims.

With reference then to FIG. 1, the present invention is illustrated in an exemplary manner in position within a powder spray booth 10. The spray booth 10 in this example is a round spray booth such as described in the above-identified pending patent application, however, any suitable spray booth configuration may be used. A round booth however is particularly well suited for use with the present invention.

The spray booth 10 is realized in the form of a canopy structure 10 having a vertically extending wall structure 12 and a ceiling structure 14 such that the canopy structure 10 is generally in the shape of a right cylinder. In this exemplary embodiment, a floor structure 16 is provided that is separate from the canopy structure 10 (for simplicity the floor and booth canopy support structures are not illustrated in detail as such description and illustration are not needed to understand the present invention). The floor 16 may be a rotatable floor with the spray booth canopy wall structure 12 and ceiling 14 being suspended above the floor 16. Alternatively, the floor structure 16 may be joined to or integral with the canopy structure or otherwise non-rotatable even if not joined to the canopy structure 10. The vertical wall structure 12 and the ceiling 14 have interior surfaces that tend to collect some amount of powder overspray that needs to be blown off as part of a cleaning or color change operation. A powder extraction duct 18 is associated with the rotatable floor 16, however, the present invention may be used with spray booth designs that do not have an internal powder extraction duct. The present invention may also be used to blow powder from the floor 16 depending on the specific floor cleaning design used in the spray booth.

The present invention then is directed more particularly to a method and apparatus for pneumatically cleaning interior surfaces of the spray booth 10, such as interior surfaces of the ceiling 14, canopy walls 12 and the floor 16 using a rotatable cleaning frame. In accordance with this aspect of the invention, a series of blow off air jets are to be transported or otherwise disposed within the spray booth 10 interior. The air jets are coupled to a source of pressurized air so as to direct an air flow at the interior surfaces to be cleaned. This aspect of the invention is illustrated in the drawings as being embodied in a cleaning apparatus 100 that includes an air manifold or frame 102. The frame 102 may be formed in any number of ways, and in the exemplary embodiment is in the form of a relatively narrow inverted-U. The frame 102 may be made, for example, from rectangular tube stock, although the tube stock may have other cross-sectional shapes besides rectangular. The material used to make the frame 102 is preferably lightweight. Suitable materials include lightweight metals and more preferably composite materials. Composite materials are preferred over metal as they tend to exhibit less electrostatic conductivity. Any suitable non-conductive lightweight yet strong material such as a fiberglass pultrusion may be used. In the preferred but not required embodiment the tubing is substantially square in cross-section.

The frame 102 in this case includes an upper crossbar section 104 and two vertically extending leg sections 106 that depend from outer respective ends (110, 112) of the crossbar section 104. Again, the particular shape of the frame 102 is not a critical aspect of the present invention and a designer will be able to modify the frame 102 geometry and profile to suit the particular cleaning needs based on the interior shape of the spray booth 10. The frame 102 profile and geometry therefore will preferably conform to the shape of the spray booth interior surfaces to be cleaned. Thus, for example, with the exemplary spray booth 10 that has a generally cylindrical profile, the frame 102 when rotating about a central axis of the spray booth 10 produces a sweeping blow off air pattern that is generally cylindrical and spaced an appropriate distance to blow off powder from the interior cylindrical wall structure.

As an alternative embodiment, the frame 102 may carry or support a pressurized source of air rather than the air passing through an internal air passage.

Each of the three sections of the frame 102 (the crossbar 104 and the two legs 106) are formed of hollow square tubes such that the interior region forms an air passage 108 (FIG. 1A). At the outer ends 110 and 112 of the crossbar section 104, the legs 106 are preferably joined thereto by a miter joint or other suitable connection. The sections 104/106 may be joined by any convenient method such as an adhesive bond. The leg sections 106 are joined to the crossbar 104 such that the air passage 108 is continuous from the crossbar 104 down through both leg sections 106.

The tubular sections 104 and 106 include a series of bores that form blow off air jets 114 (FIG. 1A). In the example of FIGS. 1 and 1A, the air jets 114 are bores through the wall structure of the tubular sections 104, 106. Although bores 114 alone may be used as a blow off air jet, a more effective cleaning air pattern may be produced by utilizing an air amplifier nozzle installed in a respective bore 114 adapted to receive the nozzle. A suitable air nozzle is WINDJET model number 727-11 available from The Spraying Systems Co. to name one example. Any suitable air nozzle or air flow augmentation device may be used. The bores 114 are preferably formed at right angles to the outer wall 116 that faces the spray booth interior surfaces IS to be cleaned. Each of the blow off air jets 114 however may be formed at any angle if so required, particularly for example to blow off powder from the corners 110, 112. The various blow off air jets 114 formed in the tubular sections 104, 106 may have different angles. The directional arrows 118 represent blow off air streams that are directed at the interior surfaces IS via the air jets 114. The directional arrows 118 in FIG. 1 however are intended to be illustrative only and do not necessarily correspond with specific air jet 114 locations nor do they represent all of the air jets 114 formed in the tubular sections 104, 106.

Those skilled in the art will appreciate that there will be alternative ways to provide a cleaning air flow toward the interior surfaces of the spray booth from the frame 102. Therefore, “air jets” should be construed broadly to include any mechanism or technique for directing blow off air (represented by the directional arrows 118 in FIG. 1) from the rotating frame 102 toward the interior surfaces IS.

The crossbar section 104 preferably spans across substantially the diameter or width of the spray booth 10. The frame 102 is sized so that the frame leg sections 106 and the crossbar section 104 are spaced close enough to the interior surfaces IS so as to be able to effectively blow off powder therefrom. A typical size of the tubular sections 104, 106 may be, for example, 3″×3″×1/8″ or 2″×2″×1/8″ although other tubing sizes may be used as required. Thus, the frame 102 is generally planar and has a narrow profile within the spray booth of only about two or three inches. This allows the frame 102 to be suspended from a conventional conveyor 122 (only shown diagrammatically), such as for example a conveyor commonly used to transfer objects being sprayed through the spray booth 10, and transported into the spray booth through slotted or other openings therein in a manner similar to parts being conveyed into or through the spray booth for spraying operations.

The crossbar section 104 includes a connector extension 120 which may be another piece of the hollow tubular stock joined to the frame 102 substantially at the midpoint of the crossbar 104. The extension 120 therefore has a central portion in fluid communication with and forming part of the air passage 108. The extension 120 thus preferably lies on the center longitudinal axis X of the frame 102 which will define an axis of rotation for the frame 102 as will be more fully described hereinafter. The extension 120 may be provided with any suitable rotatable connection to the conveyor 122 to function as an upper hub and to allow the frame 102 to be suspended from and transported by the overhead conveyor 122. The conveyor may also carry a suitable pneumatic connector or fitting 124 to connect the air passage 108 to a source of pressurized air 126. Air flow to the frame 102 may be controlled by a suitable control valve or other mechanism as required (not shown).

In accordance with another aspect of the invention, in order to provide maximum blow off coverage of the spray booth interior surfaces, the blow off air jets 114 are preferably rotated within the spray booth 10 interior. It is further contemplated that the cleaning apparatus be self-propelled or automatically rotate so as to obviate any need for a drive mechanism. In the exemplary embodiment, this may be accomplished, for example, by providing a number of propulsion air jets 130 (see FIG. 1A wherein there are illustrated three exemplary locations 130a and 130b and 130c). Location 130c would provide higher rotation speeds. The propulsion air jets 130 may be formed in a manner similar to the blow off air jets 114 such as bores through the tubular walls 116. The propulsion air jets 130 are appropriately angled so that pressurized air ejected through the propulsion-air jets 130 cause the frame 102 to rotate under self-propulsion. The propulsion air jets 130 may also function to blow off powder from the interior surfaces IS. In the example of FIG. 1A, the propulsion air jets (130a or 130b) are angled at about forty-five degrees, however, other angles may be used as required. Furthermore, depending on the particular surfaces being cleaned and the required rotation, the blow off air jets 114 may be appropriately angled to also impart the self-propelled rotation of the frame 102. Therefore, propulsion air jets and blow off air jets may be separate air jets formed in the tubular sections or some of the air jets may perform both functions or some combination thereof may be used. Other configurations may be used to impart rotating motion to the frame 102 in response to air pressure in the air passage 108. Additionally, FIG. 1A illustrates two exemplary propulsion air jet locations 130a and 130b to illustrate that the propulsion air jets 130 may be angled so as to effect clockwise or counter clockwise rotation as required (only one of the locations 130a or 130b would be used in a given frame 102). The propulsion air jets 130 may include air amplifier nozzles or other suitable nozzles.

The self-propelled rotation of the frame 102 is facilitated by the use of lightweight materials for the frame 102. By reducing the frame mass the frame 102 also avoids exhibiting a “fly wheel” effect in which it would take time to stop the rotation and also to allow the frame 102 to be easily stopped if an object accidentally contacts the frame 102 while it is turning. The frame 102 need not turn at a high speed, for example as few as 2-5 rpm may be suitable although other speeds may be realized as required.

The pneumatic connection 124 between the extension 120 and the conveyor 122 functions as an air hub along the axis of rotation X. The connection 124 can be realized in any suitable manner to provide a rotary coupling. The overall size of the frame 102, however, may cause the frame 102 to oscillate or otherwise deviate from a true rotational spin. Therefore, a stabilizer device 140 may be provided at the lower portion of the frame 102. The lower stabilizer device 140 includes a brace 142 that is connected at its ends to the lower portions of the leg sections 106. Reinforcement gussets 144 may be used to strengthen these joints. In one embodiment, the brace 142 is also formed of similar hollow tubular stock and joined to the leg sections 106 so that pressurized air also passes into the brace 142. In the center of the brace 142 is a retractable lower stabilizer hub 146. This lower hub 146 may, for example, include a pneumatically actuated piston or other device that is in fluid communication with the pressurized air passage in the brace 142. The air pressure extends a rod 148 having a rotatable cap or block 150 at the end thereof. The cap 150 engages the top of the duct 18 and is suitably conformed to the shape of the duct so as to provide, with the rod 148, a stable anchor or lower hub device 151 for the frame 102. In FIG. 1 the cap 150 is illustrated in the retracted position. For booths that do not have a duct 18 below the frame 102, the cap 150 may simply extend down to the floor 16. In any case, the lower hub device 151 is substantially coaxial with the upper hub 120 to stabilize the frame 102 while it is rotating. Other mechanism including non-pneumatic mechanism may be used to extend and retract the lower stabilizer hub. Although it is contemplated that a cleaning operation will utilize multiple rotations of the frame 102, it is also contemplated that a single revolution or partial revolution may permit cleaning of the interior surfaces. Therefore, the term “rotate” includes partial, full and multiple rotations. The frame 102, for example, may be provided with more than one cross-bar 104 and two depending legs 106.

FIG. 2 illustrates a side or profile view of the frame 102 and with the lower hub 151 in the extended position. A typical spray booth 10 includes access doors or other vertical openings D that align with the conveyor and through which the rather narrow frame 102 can be easily passed into the spray booth 10 interior. FIG. 3 illustrates that the air jets 114, 130 may include air nozzles 160 as required. FIG. 3 also illustrates the overhead conveyor 122 in an exploded view from the frame 102 and the frame extension 120. Note in FIG. 3 that the spray booth is illustrated as not having a duct at the floor, therefore, additional air jets or nozzles 114, 160 may be used to blow powder off the floor surface.

In order to further stabilize the frame 102 during rotation, reinforcement gussets 170 (FIG. 1) may be provided as needed and may have any suitable shape and size to reinforce the frame 102. Lower gussets 172 (FIG. 3) may also be used as required.

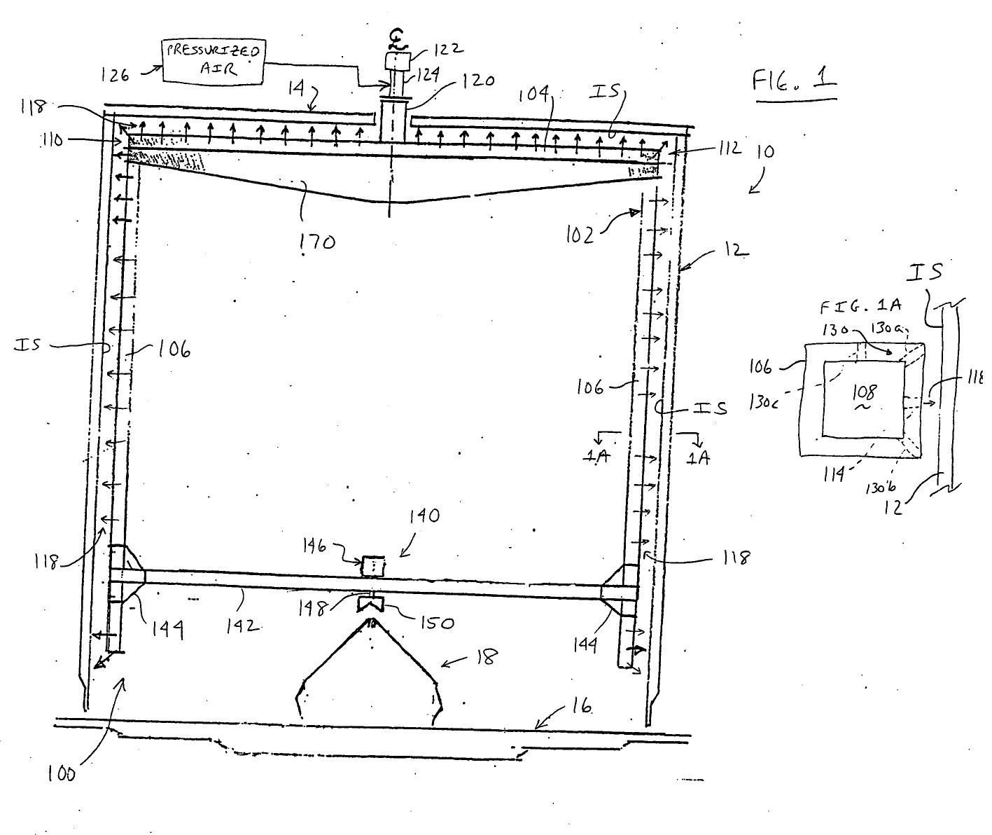

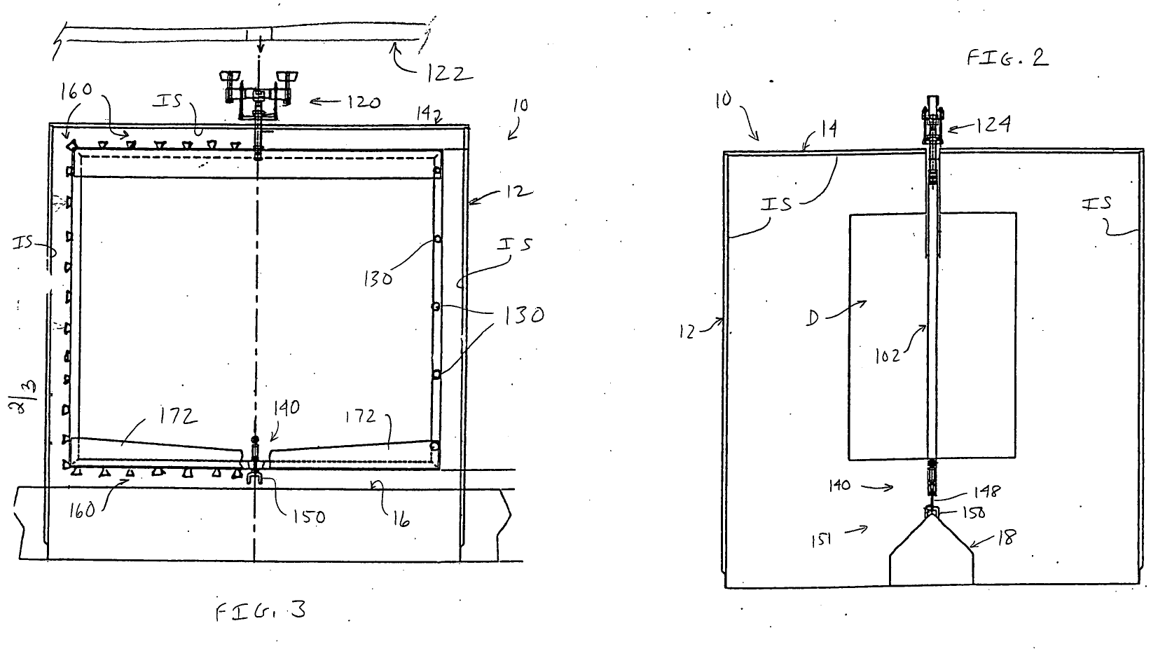

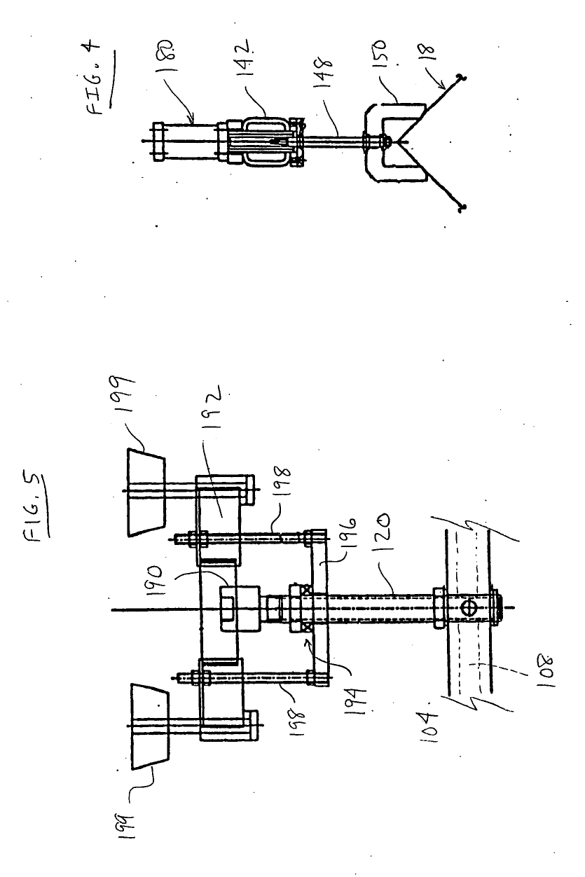

FIG. 4 illustrates in greater detail the lower stabilizer hub 146. A piston cylinder 180 is in fluid communication with the air pressure in the lower brace 142. The piston rod 148 is spring biased to the retracted position (FIG. 1) and carries at its free end the cap 150. Air pressure within the brace 142 is sufficient to overcome the spring bias and cause the piston rod 148 to extend outward to the position illustrated in FIG. 4 such that the cap 150 engages the duct 18 or other suitably stable non-rotating structure in the spray booth 10.

FIG. 5 illustrates an exemplary coupling mechanism between the frame 102 and the overhead conveyor 122. The frame tubular extension 120 has a central internal passageway in fluid communication with the air passage 108 of the frame 102. The extension 120 is joined to a rotary or swivel air connector 190 and is supported for rotation on a bracket 192 via a thrust bearing assembly 194 and holder plate 196. The bracket 192 may include alignment pins 198 that align with corresponding holes in the conveyor 122 mounting arrangement (not shown). When the bracket 192 is coupled to the conveyor 122 as, for example, by clamps 199, the connector 190 receives a fitting 124 (FIG. 1) that is connected to the pressurized air supply 126. Accordingly, the frame 102 is suspended from the conveyor 122 for rotation while receiving pressurized air from the pressurized air supply 126.

The invention has been described with reference to preferred and exemplary embodiments. Modifications and alterations will occur to others upon a reading and understanding of this specification. It is intended to include all such modifications and alterations insofar as they come within the scope of the appended claims or the equivalents thereof.

Having thus described the invention, it is claimed:

1. A pneumatic powder spray booth cleaning apparatus comprising:
a rotatable frame having an air passage therethrough; said air passage being connectable to a source of pressurized air; said frame having a height and width that allow said frame to be moved between a first position outside a spray booth and a second position inside a spray booth;
said frame having a number of air jets that are in fluid communication with said air passage and that direct an air flow at interior surfaces of a spray booth to blow off powder therefrom as said frame rotates.

2. The apparatus of claim 1 wherein said frame directs said air flow in multiple directions so that when said frame is inside a spray booth said air flow is directed at vertical wall areas and a ceiling area of the spray booth.

3. The apparatus of claim 1 wherein a number of said air jets comprise propulsion air jets to cause said frame to rotate about an axis.

4. The apparatus of claim 1 wherein said frame is mountable on an overhead conveyor for transport between said first and second positions through openings in the spray booth wall structure that align with said conveyor.

5. The apparatus of claim 4 comprising a pressurized air source associated with said conveyor; said frame having a inlet port that is coupled to said pressurized air source when said frame is in said second position.

6. The apparatus of claim 5 wherein said frame inlet port is uncoupled from said pressurized air source when said frame is in a position other than said second position.

7. The apparatus of claim 5 wherein said pressurized air source is actuated only when said frame is coupled thereto.

8. The apparatus of claim 4 wherein said frame is suspended from said conveyor by a rotatable air coupling that defines an upper hub about which said frame rotates when pressurized air is supplied to said air passage.

9. The apparatus of claim 8 comprising a lower stabilizer hub at a bottom of said frame that is coaxial with said upper hub; said lower stabilizer hub being coupled to a non-rotating member of the spray booth when said frame is rotating within the spray booth.

10. The apparatus of claim 1 wherein said air jets comprise air nozzles mounted on said frame and in fluid communication with said air passage.

11. The apparatus of claim 1 wherein said frame comprises non-metallic material.

12. The apparatus of claim 1 wherein said frame comprises composite material.

13. The apparatus of claim 3 wherein said frame comprises hollow members joined together in an inverted U-shaped configuration when said frame is in said second position.

14. The apparatus of claim 13 wherein said propulsion air jets comprise bores formed through wall sections of said rectangular members and at an angular orientation to cause said frame to rotate in a predetermined direction when pressurized air is ejected through said propulsion air jets.

15. The apparatus of claim 13 wherein said blow off air jets comprise air bores formed through wall sections of said rectangular members and at an angular orientation to cause pressurized air to impinge on interior surfaces of the spray booth when pressurized air is ejected through said blow off air jets.

16. A method for cleaning a powder spray booth, comprising the steps of:
a. transferring into the spray booth a plurality of blow off air jets that direct pressurized air at interior surfaces of the spray booth;
b. coupling a pressurized air supply to said blow off air jets; and
c. rotating said blow off air jets about an axis to blow off powder from said interior surfaces.

17. The method of claim 16 comprising the step of using pressurized air through a number of propulsion air jets to at least partially rotate said blow off air jets.

18. The method of claim 16 comprising the step of using an overhead conveyor to transfer said air jets into and out of the spray booth.

19. A pneumatic powder spray booth cleaning apparatus comprising:
a powder spray booth having vertically extending walls, a ceiling and a floor;
a rotatable frame having an air passage therethrough; said air passage being connectable to a source of pressurized air; said frame having a height and width that allow said frame to be moved between a first position outside said spray booth and a second position inside said spray booth;
said frame having a number of blow off air jets that are in fluid communication with said air passage and that direct an air flow at interior surfaces of said vertically extending walls and ceiling to blow off powder therefrom while said frame rotates.

20. The apparatus of claim 19 wherein said frame rotates about a central longitudinal axis of said spray booth.

21. The apparatus of claim 19 wherein said frame is transported into said spray booth by an overhead conveyor that is also used to transfer objects to be sprayed inside said booth for spraying operations.

22. The apparatus of claim 19 comprising a number of propulsion air jets that cause rotation of said frame about said axis.

23. The apparatus of claim 19 comprising an upper rotatable air coupling for coupling said frame to a pressurized air supply.

24. The apparatus of claim 23 comprising a lower stabilizer hub that is substantially coaxial with said upper rotatable air coupling.

25. The apparatus of claim 19 comprising a duct disposed near a floor of said powder booth; said duct having a negative pressure air flow therethrough that extracts powder from said spray booth that has been blown off said interior surfaces by said frame.

26. The apparatus of claim 25 wherein said duct is coupled to a powder recovery apparatus.

27. The apparatus of claim 19 wherein said frame is rotationally suspended on bearings from a conveyor.

28. The apparatus of claim 19 wherein said spray booth is substantially cylindrical.

29. The apparatus of claim 19 wherein said frame is rotationally supported at a lower end by a stabilizer hub that contacts an extraction duct in said booth.

30. The apparatus of claim 19 wherein rotation of said frame is self-propelled.

31. The apparatus of claim 30 wherein said self-propelled frame rotates in response to air flow within said frame.

32. A cleaning system comprising:
a powder spray booth that is generally a vertical cylinder;
an overhead conveyor;
said spray booth having an opening for parts carried by the conveyor into and out of said spray booth;
said frame being suspended from said conveyor and moveable through said opening for positioning within said spray booth; and
a cleaning frame having vertically extending legs which are positioned adjacent cylindrical interior surfaces of said spray booth;
said cleaning frame rotating to remove oversprayed powder from said interior surfaces.

33. The apparatus of claim 32 wherein compressed air jets are supported by said cleaning frame to spray compressed air onto said interior surfaces for removing oversprayed powder therefrom.

34. The apparatus of claim 32 wherein said frame rotation is self-propelled by compressed air jets supported by said frame.

35. The apparatus of claim 34 wherein said frame is supported on a bearing device.

36. A powder booth cleaning apparatus comprising:
a powder spray booth;
a cleaning frame conforming to interior surfaces of said spray booth;
said cleaning frame having associated air jets that cause said cleaning frame to rotate.

37. The apparatus of claim 36 wherein said frame is supported on bearings for rotation.
